(19) United States
(12) Patent Application Publication
(10) Pub. No.: US 2002/0178216 A1
(43) Pub. Date: Nov. 28, 2002

(54) Method and system for data management

(76) Inventors: Stefan Walther, Mainz (DE); Kambiz Darabi, Mainz (DE)

Correspondence Address: KRIEGSMAN & KRIEGSMAN, 665 FRANKLIN STREET, FRAMINGHAM, MA, 01702, US

(21) Appl. No.: 10/096,063

(22) Filed: Mar. 12, 2002

Related U.S. Application Data
(60) Provisional application No. 60/281,075, filed on Apr. 3, 2001.

(30) Foreign Application Priority Data
Mar. 13, 2001 (DE) 101 12 409.0

(51) Int. Cl. G06F 15/16

(52) U.S. Cl. 709/203

(57) ABSTRACT

The present invention concerns a method for data management, wherein data are entered and processed on at least one mobile computer (20) provided with a software program (front end); data are collected and stored on at least one central computer (40, 50) by means of a software program (back-end system), wherein an exchange of data between the at-least one mobile computer (20) and the at-least one central computer (40, 50) is carried out via at least one local computer (30); and the software (middleware) of the local computer (30) serves at least also for intermediate conversion and interface control. It is provided according to the invention that general data accessible to each mobile computer (20) are collected and stored on the at-least one central computer (40, 50) and that application-specific individual data for one or more mobile computers (20) are collected and stored on a computer (20, 30, 60) by means of another software program (customizer), whereby an exchange of data between the mobile computer (20) and computer (20, 30, 60) is made such that the software (front end) present on the mobile computer (20) is configured in an application-specific manner.

The present invention concerns a method for data management according to the preamble of claim 1 as well as a system for data management according to the preamble of claim 9.

The subject of the invention thus concerns mobile application solutions for data management. Based on the mobile nature of several job descriptions, there is a great need for such mobile application solutions, for example, for so-called handheld or pocket-size computers, which assure a mobility that is as high as possible. Highly mobile applications are desired, which run on miniature mobile devices, to make possible group work and network capacity as well as a connection to central databases.

A particular need, for example, is related to the management of patient data in a hospital: A physician wants to document a diagnosis at the bed of his patient during his ward visit. He loads the patient data beforehand onto his mobile pocket-size computer from a central information system by means of a mobile application, documents simply and rapidly by means of prepared boiler-plate text modules, and again inputs these into the hospital documentation system. From there they can be further processed in the usual form.

Such a method or system according to this concept is described in WO 99/41682. The known method or system concerns exclusively the management of patient data in the hospital. The known system essentially comprises at least one mobile computer, a local application computer and at least one central computer. The local application computer mediates the exchange of data between the mobile computer and the central computer, for example, a database with patient data and makes available these patient data as well as forms, input masks and the like for the input of patient data. Thus the physician can call up patient data at the sick bed, update these data or enter new data and store these on the local application computer. The new data are then further processed, for example, read into a central patient file stored on a central computer or newly formatted, for example, in order to file the data in various databases on different central computers. The data transfer and the data matching between the mobile computer and the local application computer can be conducted synchronously, for example, over a telephone or wireless connection or asynchronously by docking the mobile computer to a terminal.

It is a problem in this solution proposal that this method or system can be adapted only with great difficulty to the individual requirements of individual users. In fact, pregiven lists can be maintained with this system, but basically a change of the application running on the mobile computer is only possible with a new version of the [same] program. This also limits the application of the known method or system to additional fields of application, such as sales, inventory or service. In all of these fields of application, for transcribing a solution that is as optimal as possible, the mobile unit must be connected to the data from the central system and work in the group must be made possible. In various fields of application, however, different requirements exist depending on the objective, both with respect to the mobile components as well as with respect to the connection to the central databases. All of the solutions available up to the present time consider only the mobile component as a “single place”, whereby only data matching with a single computer is possible. The single-place version can be adapted exclusively within the mobile application itself, which is time-consuming and can be accomplished only in a very troublesome manner due to the poor input possibilities of small mobile machines.

The object of the present invention is to further develop the known method or system in such a way that it can be adapted to different requirements of the individual user in various fields of application.

The application can be configured individually, but a corresponding application adaptation that is easy to operate and to maintain centrally for all users must be made possible.

The solution consists of a method with the features of claim 1 as well as a method with the features of claim 9. According to the invention, a system is thus provided, in which a local computer or its software (middleware) mediates the communication between the mobile computer and the central computer, and matches, converts and/or formats data. The local computer thus serves primarily as an intermediate converter and interface controller. In addition to the local computer, an intermediate computer is provided with application software (customizer), with which the software on the mobile computer is adapted to individual requirements. The data exchanged between the central computer and the mobile computer via the local computer are of a general nature and are not individualized. Examples include general patient data in a hospital database, general data on inventories, general statistical data, general management and accounting data. The special application software on the intermediate computer (customizer) supplies individualized data and individual processing models, for example, application-specific forms and data sheets to be filled out, standardized form entries, automated inquiry routines, boiler-plate text modules, individual data, lists and protocols, new menu structures or adaptation of existing menus. Thus, the general data originating from the central computer can be individually adapted, evaluated, and utilized. The application software can also make available simultaneously these individualized data to several users of mobile computers with the same requirements (for example, several physicians of the same department, several agents in the field, etc.) after the data have been adapted by a user. Thus, a central adaptation of the software of the mobile computer takes place. The application software permits the simple designing of personal programs and processes new data and program elements in an interplay with the central computer and/or the local computer.

The present invention thus follows a generic and modular approach, i.e., in addition to the connection to central databases, there exists separate application software. Typical “working data”, which are used frequently, can be placed together centrally and maintained with this software. These data, but also fields, configurations, menus, menu structures, etc. are then played over to the mobile computer. This individual configuration can work together with one or more central computers by the [intermediate] mediation of a local computer and its software. Depending on the individual configuration, any authorized user can load and process general data from the central computer on the mobile computer via the local computer and its software. The processed data are stored again and made available to the central computer via the local computer. Thus, any individual user can simply adapt applications provided for his mobile computer, e.g., conveniently maintain lists or list entries, so that individual care can be brought to his requirements.

The basic idea of the solution is to make possible a simple design of personal programs on the mobile device for the user in a form in which this program can then further process new elements in an interplay, e.g., with a central database of the company.

Advantageous enhancements result from the dependent claims. The mobile components can be connected by means of a network, so that working within the group is made possible. In matching the mobile system, changes can thus be transmitted to all desired end devices. This process functions network wide, so that adaptations can be centrally undertaken and then can automatically be distributed to all users.

The customizer may also be installed on a computer, for example, a server, or also, particularly for smaller changes, on the mobile device. In addition to this, front end and middleware or front end and customizer or middleware and customizer may be installed on the same computer, for example, the local computer, the intermediate computer or even the mobile computer.

The middleware and the customizer including the interfaces can be produced in the programming language Java, since this programming language offers advantages in application due to its database interfaces and its portability.

The connection between the mobile computer and the local computer can be made asynchronously, for example, by means of a plug-in module or synchronously by a network, also a wireless connection. The communication between the local computer and the central computer preferably is conducted by means of standardized or individual interfaces.

Preferably, the intermediate computer is accessible only to a selected circle of users and the customizer contains authorization protocols and routines for controlling the access authorization of the respective user.

An example of embodiment of the present invention is explained in more detail in the following on the basis of the appended drawings. Here,

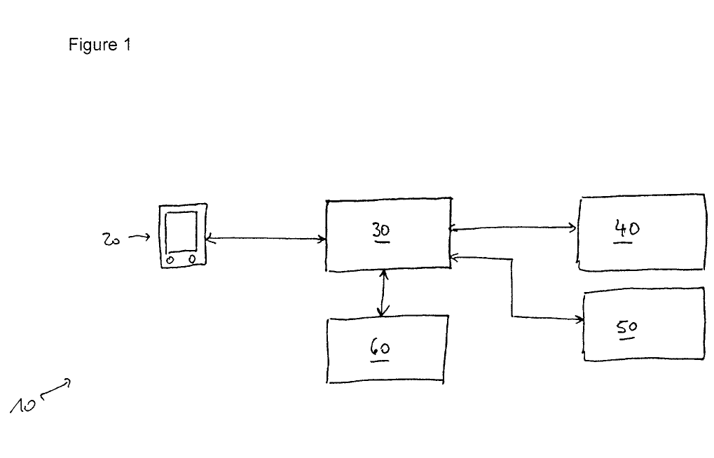

FIG. 1 shows a schematic representation of a system for data management according to the invention;

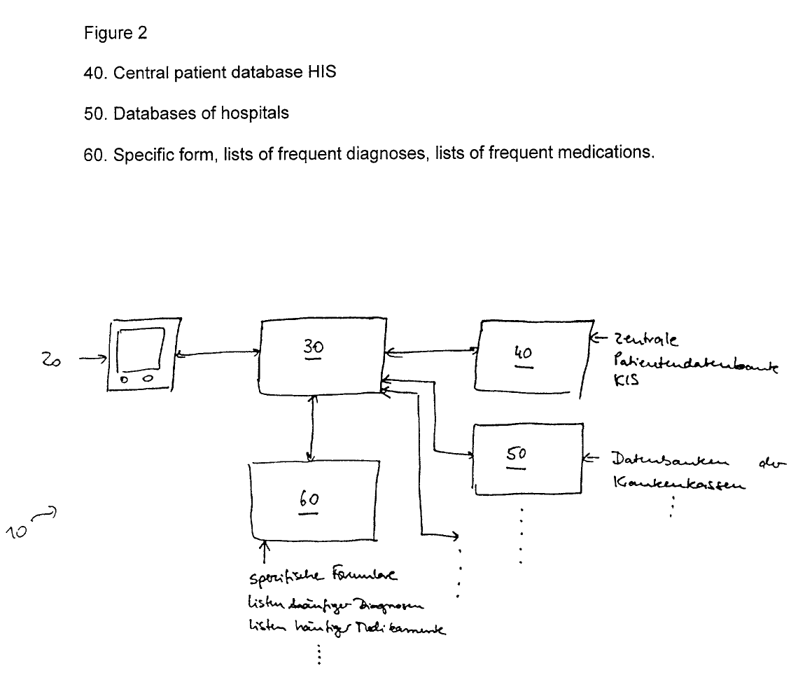

FIG. 2 shows a schematic representation of the application of the system according to the invention for the management of patient data;

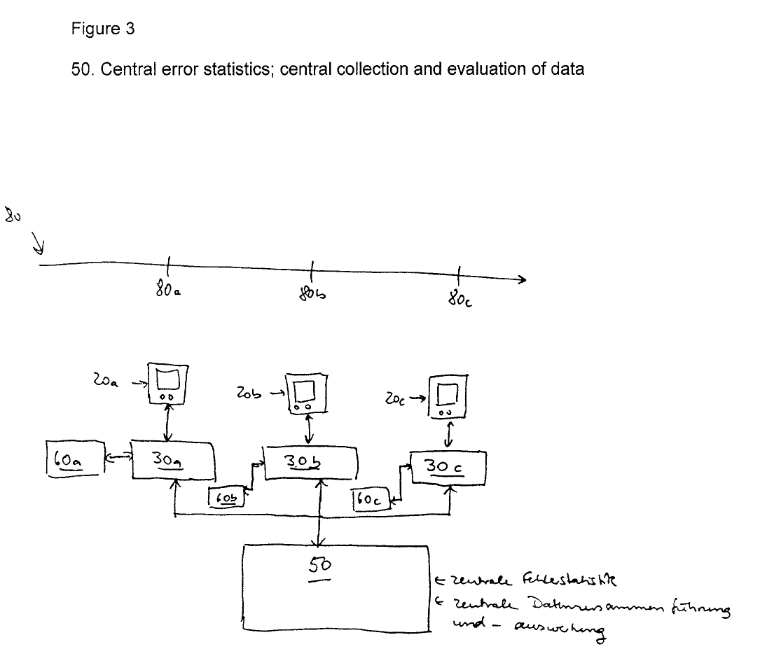

FIG. 3 shows a schematic representation of the application of the system according to the invention for quality control of production lines;

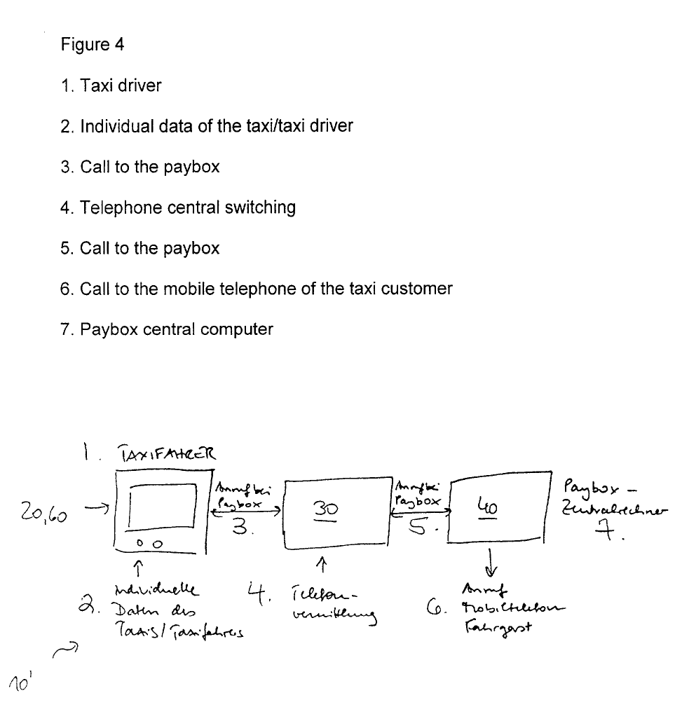

FIG. 4 shows a schematic representation of the application of the system according to the invention for the paybox system (payment by mobile telephone);

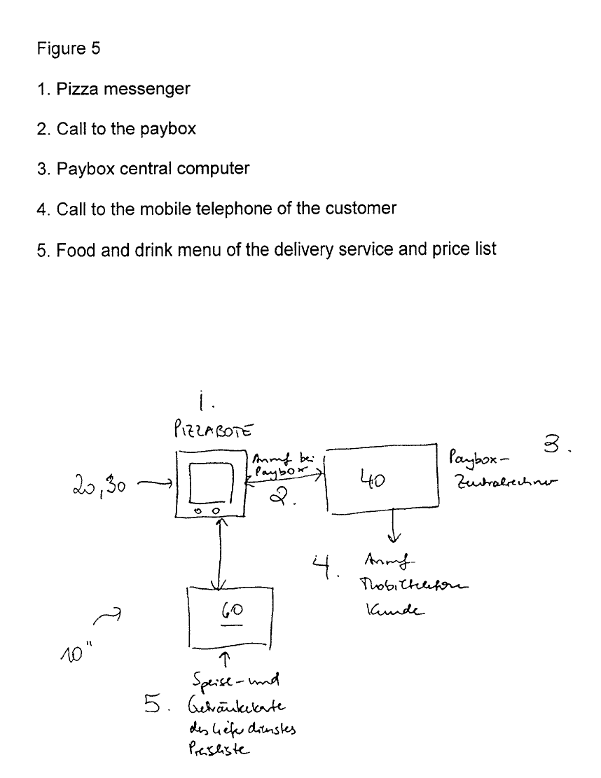

FIG. 5 shows a variant of the application according to FIG. 4;

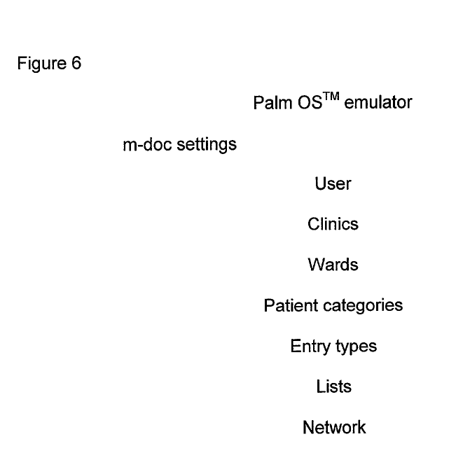

FIGS. 6 to 18 show example representations of the display on a mobile computer for the various applications according to FIGS. 1 to 5.

The overall system 10 is comprised of several components and modules. Each user communicates with the system via a mobile computer 20 by means of a software component, which is named “front end” in the following. The mobile computer in turn communicates with a local computer 30 on which another software component, called middleware below, is installed. This local computer 30 finally produces the connection with the one or more central computers 40, 50 and mediates the data exchange between mobile computer 20 and central computers 40, 50. Different systems, for example, database systems, which are designated overall as back-end systems in the following, can be installed on the one or more central computers 40, 50. A special component, named customizer below, which is installed on an intermediate computer 60, which communicates with the local computer 30, serves for adapting the front end to the individual requirements of the respective user.

Of course, customizer and middleware can be installed on a [single] computer as well as, for example, front end and customizer or front end and middleware.

Front End

The front end is the user interface for the user. Data will be both displayed as well as manipulated by the user herewith. For this purpose, various masks and lists are made available. The design of the user interface is particularly optimized for small end devices which usually have only limited display.

The front end can be matched with the back-end system either synchronously or asynchronously, each time depending on the requirement for mobility and data availability. Synchronous matching means that the mobile computer 20 is suitable for application in a wireless network. The user is thus continuously online by means of the local computer 30 connected with the one or more central computers 40, 50, so that changes can be undertaken immediately in the middleware and/or in the back-end system. In the case of asynchronous matching, the data are matched with the local computer 30 via a stationary connection. If the user changes the data on the mobile device, then these changes are made effective after a repeated matching in the middleware and/or in the back-end system.

The front-end component generally runs on all mobile computers, such as mobile telephones (for example, with UMTS standard), handheld devices, palmtops or laptops. So-called handheld devices (or also pocket-type computers, personal digital assistants (PDAs), etc). are preferred at the present time. The most broadly used PDA is manufactured by the Palm™ company and is operated with the Palm Operating System (Palm OS). Additional Palm OS devices are produced, among others, by the Handspring and TRG companies. In addition to the Palm OS devices, the front-end hardware can be operated with the operating system WinCE of the Microsoft company. In this case, there are a multiple number of manufacturers. Future developments in this field are to be expected, particularly in the migration from the conventional cell phones found on the market to mobile miniature computers.

The mobile computer 20 can be connected in various ways to the local computer 30. If mobile computers 20 will be joined by a wireless network, then e.g., DECT or Bluetooth networks are suitable. Data matching is produced by means of a stationary station, and thus the latter station or the PC joined to the mobile station will be connected to the local computer 30 via a network. A connection via GSM is also possible. In addition, future developments can be considered, such as, e.g., combinations (so-called clones) of the current cell phones and mobile computers.

The front end [program] can be produced preferably for small mobile computers, for example, with the operating systems Palm OS, Window CE or EPOC. By the use of a portable programming language, for example Java, it is easily possible to support other existing and new hardware devices. The front end program can read in the application modules (which lists, which menus will fulfill which functions, etc.) produced by the customizer in the form of an application description, by means of an expressly [proprietary] defined interface. The application description thus corresponds in a certain sense to an API (Application Programming Interface). After setting up the front end, the data which were delivered by the middleware are processed, modified, and again sent back to the middleware by this front end. In the version for the local computer 30, this functionality can be provided by means of Java Beans and in the version for the mobile computer 20 can be provided in a direct form by the specific tables of the mobile computer.

Middleware

The front end can communicate smoothly with the back-end system present each time, if suitable middleware is utilized. The middleware is designed for a local computer 30, which can be preferably a central server, commonly sold on the market, or a personal computer (PC) connected by a network, each time depending on the distinct shape and size of the total system. All solutions are possible here with respect to the operating system, but preferably those on which the programming language Java is available.

The communication with one or more central computers 40, 50, thus the back-end systems, is made either based on standardized interfaces or based on specially developed interface solutions. In both cases, a conversion of the required extract from the data model of the back-end system to the data model of the front-end system and vice versa is conducted. This conversion or formatting will be undertaken by the middleware.

In addition, the middleware program also has complete interfaces for the mobile computer 20. (In the case of a Palm™, this would be, e.g., an expansion of the so-called “HotSync” program.) It is assured thereby that the data, which come from the customizer and from one or more central computers 40, 50, thus different back-end systems (e.g., SAP), are assembled in suitable form and are made available to the mobile computer 20 in the assembled form.

The middleware can be produced in several versions, for example, one each for the local computer 30 and/or intermediate computer 60 (for example, for the Linux and Windows operating systems) and for the mobile computer 20. In the latter case, this preferably involves a smaller middleware component, which runs, for example, on a handheld [device].

The components of the middleware provided for the local computer 30 or the intermediate computer 60, in addition to various other interfaces, for example, also has BAPI interfaces to SAP R/3 in the versions 4.x of the modules MM and IS-H. Business objects, which can be addressed via Java Beans have been compiled along the programming guidelines of SAP for this purpose. In the direction of the front end (for example, the PDA of the Palm Company), a connection interface will also be addressed via Java, which engages directly in the HotSync protocol of the PDA and thus makes possible the synchronization to the front end.

Within the middleware, in addition to a highly complex programming part, a relational database also runs, which makes possible an addressing of its tables via JDBC. The data from various conversions by the front end are tested for consistency and brought together in this database by the functions of the middleware. In addition, the customizer addresses this database via Java Beans in order to make possible a database-supported catalog maintenance here. Also, the menu structure on the mobile computer 20, which is desired by the user, is stored in this database. Based on the menu structure that is adapted specifically to the user, the database is addressed directly via JDBC.

The PDA component of the middleware makes possible the connection to a central database system by processing the data and menu structures previously modulated by the customizer. For this purpose, the data of the front end are assembled with the data made available by the customizer and processed by synchronous or asynchronous protocols. This version may be produced, for example, in a Basic dialect, since no JVM (Java Virtual Machine, the run-time basis of Java on a computer) with acceptable performance is available with currently available processor technology.

Customizer

The front end, thus the concrete application on the mobile computer 20 will be adapted to the individual templates and requirements of each individual user, each time dependent on the field of application and the objective. The customizer serves for this purpose. It conducts an adaptation of the front-end component and thus the total mobile system from a central point. The customizer usually runs on a PC or a server (this may also be the PC or server on which the middleware is installed), which makes possible an essentially more efficient processing of the data in comparison to mobile end devices, but may also be installed on the mobile computer 20, in the case of smaller applications.

The individual data or the individual lists are selected and processed in the customizer, and the front end [program] will make these available on the mobile computer 20. In addition, an adaptation of the menus or the menu structure can be produced here. After a matching of the front-end component with the middleware and/or the back-end systems, the changes are made available to the end users. In this connection, it is particularly advantageous that lists, etc. need not be maintained by individual users but are made available centrally to all users, since they are maintained by a central administrator. As a rule, only a selected number of users has access to the customizer. The customizer makes the appropriate changes and thus makes them available to all mobile connected users. The corresponding authorization protocols are a component of the program.

The data of the customizer are maintained in a database structure provided for this purpose and can easily be expanded. For the new system or for a change of individual models for the mobile application, an appropriate user interface is made available, which makes it possible for the user to rapidly and conveniently change or add data.

In addition, the customizer can be made available, for example, in a version for the intermediate computer 60 and/or local computer 20* or in a version for the mobile computer 20. sic; local computer 30?-Trans. Note

The version for the intermediate computer 60 or the local computer 30 may also be produced in Java. The customizer converts a user-friendly surface, for example, by means of click boxes, written with Java Swing Libraries, into a structure of boiler-plate text modules, lists and menus, which are visible in the next synchronization command on the mobile computer 20. In order to assure the simultaneous support of several mobile computers 20, the filing of the data made available by the customizer in a proprietary database is assured. Necessary new tables are prepared here via JDBC, instead of addressed via the generated Beans. These contents of the database are then converted by a function set in the customizer, which reads out the boiler-plate text modules and menu structures for the front end of the mobile computer 20, whereby the data structures of the local computer 30 or of the middleware have been examined beforehand for consistency. In the conversion for several mobile computers 20, this function set is addressed each time, which then converts and installs the lists, text modules and menu structures desired for the corresponding mobile computer 20.

The smaller version of the customizer for the mobile computer 20, particularly a PDA, preferably does not support a definition of menu structures, but only the definability of lists and boiler-plate text modules. It is produced in the above-named Basic dialect, but is otherwise structurally similar to the larger version of the customizer, although very simplified.

Back-End Systems

Various central data-maintenance systems are used as back-end systems. For example, hospital information systems (e.g. SAP R/3 with the modules IS-H and IS-H*med), enterprise resource planning (ERP) systems, sales information systems and customer relationship management (CRM) systems are included in such systems. The connection of the local computer 30 to the central computers 40, 50 or the back-end systems preferably is provided via a network. The exchange of data is made via a standard interface or specially prepared communications software.

The method according to the invention can be conducted as follows: First, the user identifies himself on the respective mobile computer 20 with user name and password. When the connection has been made successfully, after a matching with the middleware of the local computer 30, the user receives the currently available information from the central database of the back-end system (e.g., customer data) as well as from the customizer (e.g., new model tables and templates). The information is made available to the user in list form or in the form of selection fields. Search functions for the database or for individual lists are also available. Various tools, for example, selection lists, predefined boiler-plate text modules, yes/no fields and the input of free text are made available to the user for manipulation or new input of data. After the changes or new inputs have been made, the front end is matched with the back-end system, so that the centrally maintained data are again updated.

If a user wishes to conduct a matching of the data of the front end with the back-end system, a network connection is first produced between the mobile computer 20 and the local computer 30. The inquiry is then processed therein. If data from the back-end system are to be displayed or modified, the local computer 30 produces a connection to one or more central computers 40, 50, thus to the back-end system, preferably via a network. Then the required data from the back-end system are loaded or modified data are rewritten to the back-end system. The middleware also provides for the processing of a match with the data of the customizer.

The data can then be processed on site on the mobile device with the front end, thus, e.g., at the hospital bed or at the customer's office, i.e., documentation can be prepared, calculations can be made or inquiries can be conducted. The data processed in this way are then intermediately formatted via the middleware and again transferred to the one or more central computers 40, 50, for example, a proprietary database or a central database (e.g., SAP).

Various application examples of the system or method according to the invention will be described below.

1. Management of Patient Data (see FIG. 2, FIGS. 6 to 14).

The function of the customizer for this application can be described as follows: Each specialized department has different services and must make different diagnoses. The diagnoses, medications and services relevant to the respective department are prepared in the customizer in the form of lists. In addition, new lists can be prepared for storing boiler-plate text modules for, e.g., physicians' letters, ward lists or telephone numbers, but also lists with the most frequent ICD10 key codes for the user and OPS for the automatic coding of diagnoses and services directly on the mobile computer 20. This can be done in the normal case only on local computer 30, for example, a department server. After a matching of the mobile computer 20 with the local computer 30, each physician using the system automatically receives the updated version of the lists and text modules.

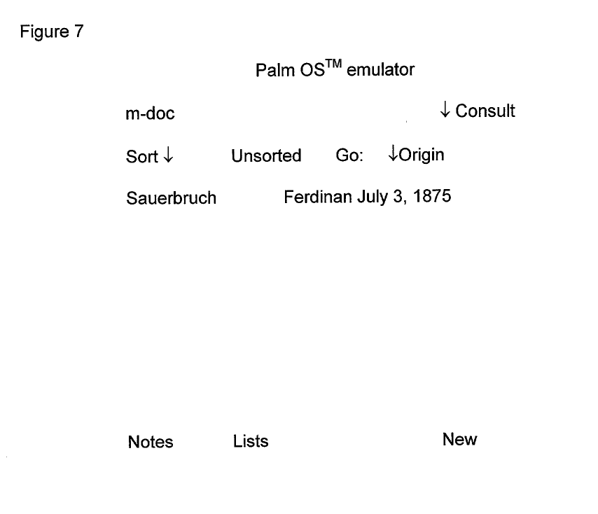

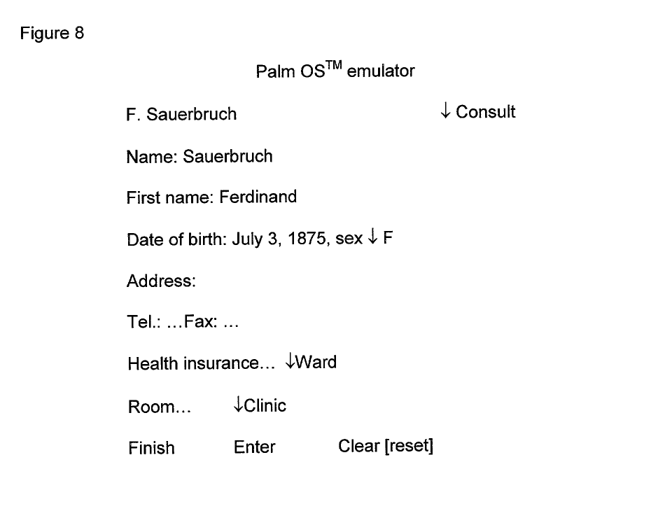

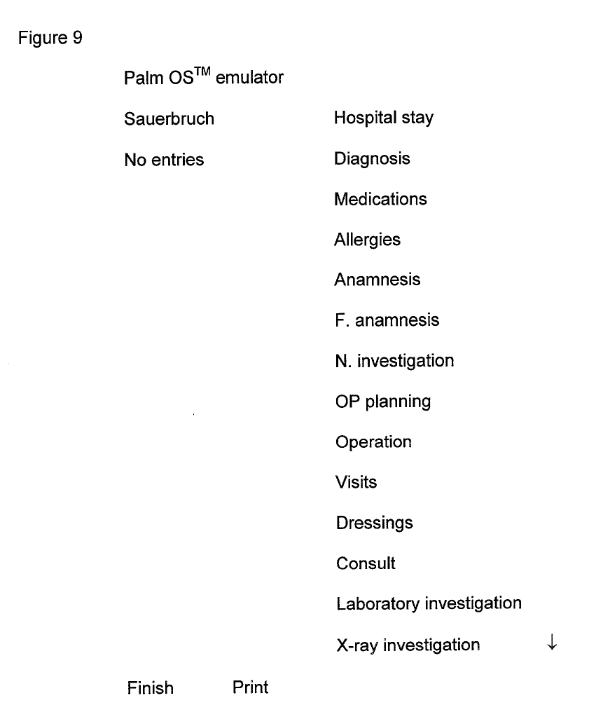

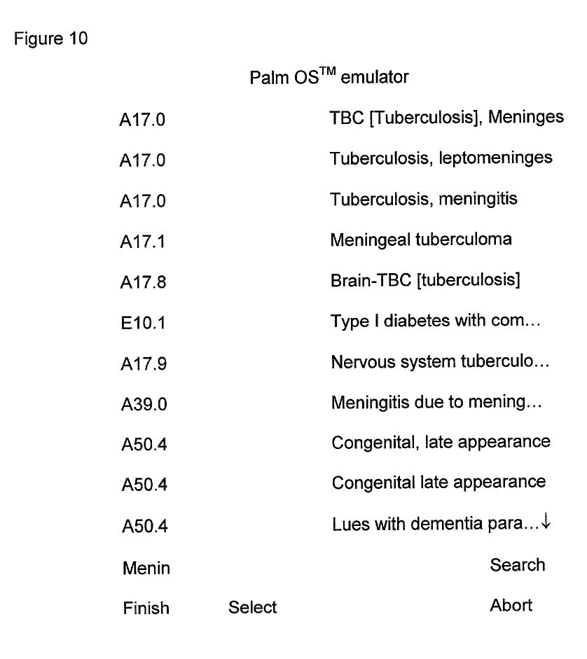

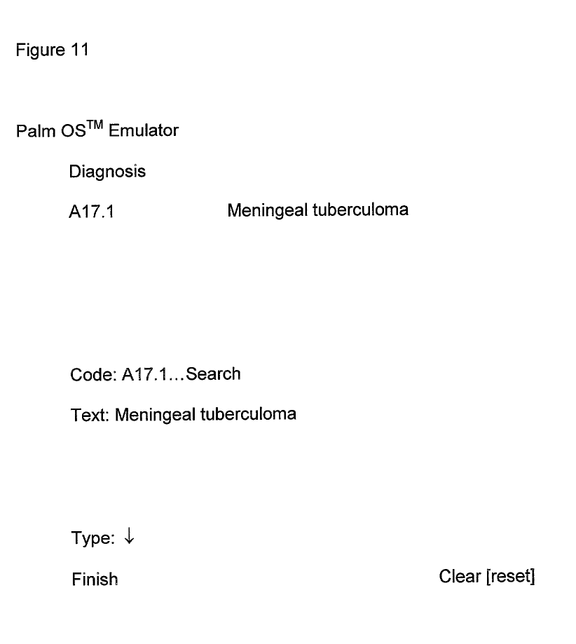

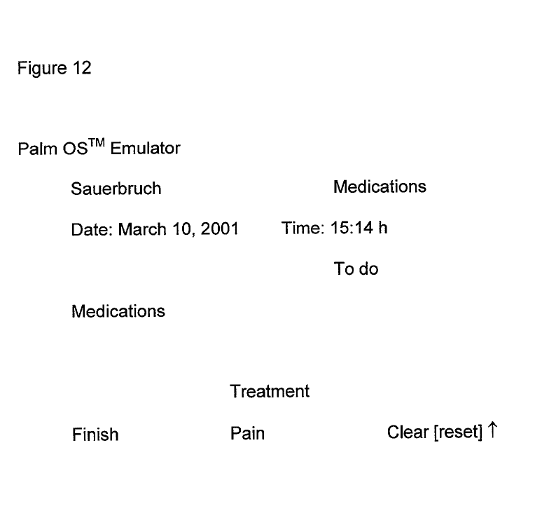

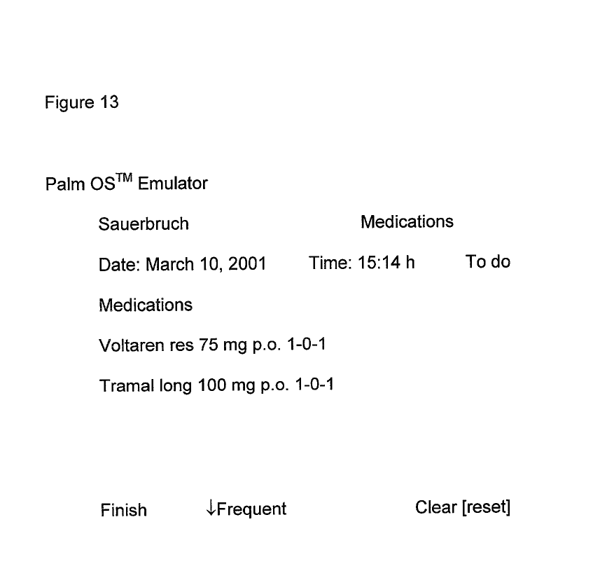

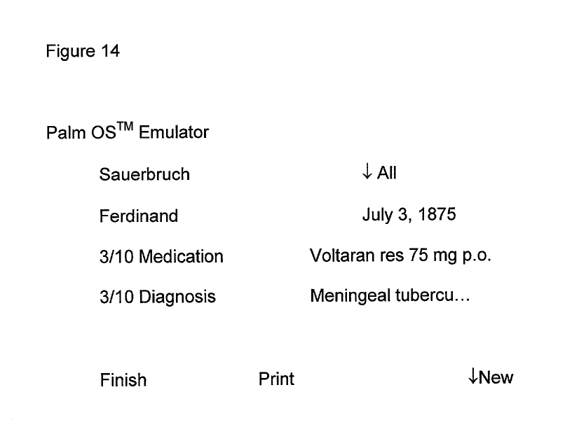

Prior to visiting the patient, the physician enters the relevant patient data on a form (for a newly admitted patient) (see FIG. 6), and this form is made available specifically for the specialist department by the customizer. Otherwise, [if it is not a new admission] the physician matches (e.g., asynchronously) on his mobile computer 20 the patient database relevant to him (see FIGS. 7, 8). Thus, the updated patient data are available to him. In the course of the patient visit, he determines e.g., diagnostic and services data (see FIG. 9) and cuts and pastes templates. Thus, e.g., a list of the possible or most frequent diagnoses in the respective specialist department is made available to him by the customizer (see FIGS. 10, 11) as well as medications (FIGS. 12, 13, for example, the most frequently used analgesics) as well as set of text modules and other lists adapted to his specialist department. The physician therefore no longer needs to input the individual items manually into the mobile computer 20, but rather a simple checking of an item in a list is sufficient. After the patient visit has been completed, he again conducts a matching (see FIG. 14). The new data are thus filed in the one or more central computers 40, for example, in the hospital information system, for further processing.

In the first matching, data are first requested by mobile computer 20 or by the front end from the local computer 30. The middleware examines the authenticity of the physician [user] and prepares the connection to the central computer 40, 50, for example, to the hospital information system (HIS) in order to transfer the data (e.g., patient data) to the mobile computer 20 or the front end. The connection to the HIS is produced, e.g., via a standardized HL7 interface. After the physician has visited the patient, a repeated matching of the data of mobile computer 20 in the direction to the HIS is made via the local computer 20 or the middleware containing, e.g., documentation or laboratory [test] requests on the mobile computer 20 or the front end. If new, individually adapted lists (e.g., specialized department-specific diagnoses) or application data will be entered on the mobile computer 20 or the front end, a matching with the data of the customizer will be made by means of the middleware.

2. Control of Production Lines (FIG. 3)

Quality controls are established along a production line 80, for example, in automobile production, at individual production stages 80a, 80b, 80c. Each control point is equipped with a mobile computer 20, which is provided with specific data (tables, lists, etc.) for the pregiven quality controls by means of a proprietary local computer and customizer. Of course, the individual local computer 30 and/or customizer can be found on a common computer, for example, a server. Each user at each control point enters the corresponding data into the mobile computer for each controlled product, or fills out the form provided in advance by the respective customizer. The data are transmitted by the one or more local computers 30 to a central computer 50, which puts together the data for each product and evaluates these data. The local computer 30 or the central computer 50 also supplies a quality report with a summed-up error protocol for each product at the end of the production line, i.e., the summation of the error messages determined at the control points, which is printed out at the end of the production line.

3. Outside Agents (FIG. 1)

With the system or the method according to the invention, outside employees with the mobile computer 20 can query, for example, inventory status or updated information on quotations and conditions and can place orders. Each time depending on the field of activity, the customizer delivers, for example, responses to RFQs of customers, automated inventory inquiries, wherein the most frequently queried products are listed first, text modules for common inquiries at the central computer or frequent orders, etc. The system according to the invention can thus serve here, for example, as a service system, as a CRM module (customer relationship management) or as a mobile ordering and purchasing system (sales system).

4. Payment of Taxi Rides with the Paybox System (FIG. 4)

In this case, the taxi driver is the user of the mobile computer 20, which serves simultaneously as intermediate computer 60, since the customizer is integrated in the mobile computer. The customizer makes available the individual data of the taxi or the taxi driver while the front end determines the charged amount and makes a telephone connection to the local computer 30, for example via a GSM module. The local computer 30 in turn switches between different front ends of individual mobile computers 20 (for example, different taxi companies) and produces the telephone connection to the paybox central computer, which functions here as central computer 40. Then the callback to the mobile telephone of the taxi customer can be produced, by means of which the customer confirms payment.

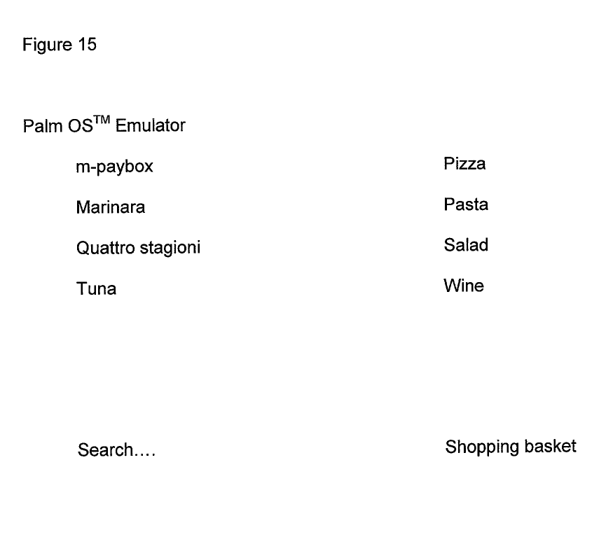

5. Payment of delivery services with the paybox on the example of a pizza service (FIG. 5, FIGS. 15 to 18)

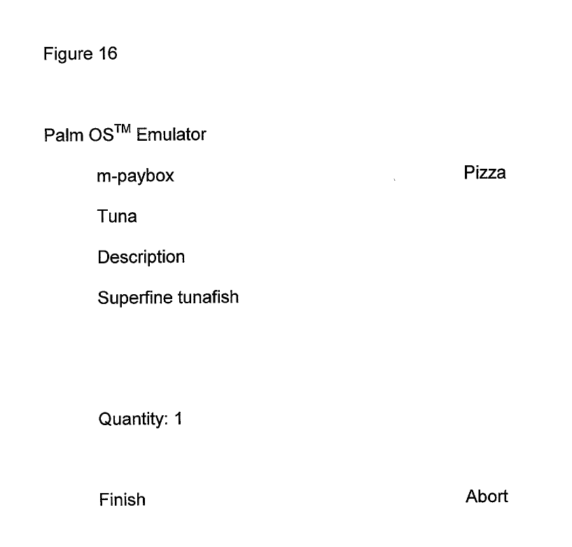

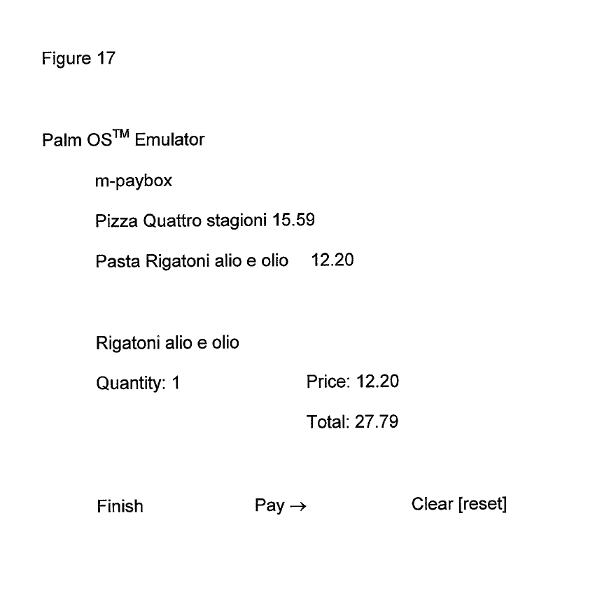

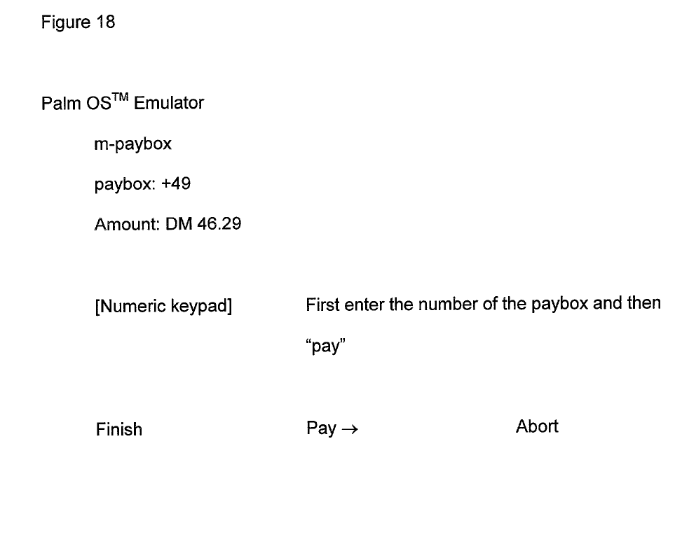

Here, the messenger of the delivery service is the user of the mobile computer 20. The food and drink menu of the delivery service plus the prices are made available to the mobile computer by means of text modules via the customizer. The front end contains a program for determining the payment amount as well as the middleware for producing the telephone connection with the paybox central computer 40. For payment of the calculated amount, the messenger types in the ordered food items in the mobile computer (FIGS. 15, 16). The front end determines the payment amount (see FIG. 17), and makes the connection with the paybox central computer (see FIG. 18) and transmits the payment data of the customer. Then the callback is made again from the central computer 40 to the mobile telephone of the customer for confirming the payment.

1. A method for data management, wherein
data are entered and processed on at least one mobile computer (20) provided with a software program (front end),
data are collected and stored on at least one central computer (40, 50) by means of a software program (back-end system)
wherein an exchange of data between the at-least one mobile computer (20) and the at-least one central computer (40, 50) is undertaken by means of at least one local computer (30) and the software (middleware) of the local computer (30) serves at least also for the intermediate conversion and interface control,
is hereby characterized in that
general data accessible to each mobile computer (20) are collected and stored on the at-least one central computer (40, 50),
and that individual data for one or more mobile computers (20) that are application-specific are collected and stored on a computer (20, 30, 60) by means of another software program (customizer),
whereby an exchange of data between the mobile computer (20) and the computer (20, 30, 60) is made in such a way that the software present on the mobile computer (20) (front end) is configured in an application-specific manner.

2. The method according to claim 1, further characterized in that the exchange of data between the mobile computer (20) and computer (20, 30, 60) is made by means of the software (middleware) of the local computer (30).

3. The method according to one of the preceding claims, further characterized in that the additional software (customizer) is stored on a separate intermediate computer (60).

4. The method according to one of claims 1 and 2, further characterized in that the additional software (customizer) is stored on the local computer (30).

5. The method according to one of claims 1 and 2, further characterized in that the additional software (customizer) is stored on the mobile computer (20).

6. The method according to one of the preceding claims, further characterized in that front end and customizer or front end and middleware or customizer and middleware are stored on the same computer.

7. The method according to one of the preceding claims, further characterized in that the additional software (customizer) is provided with at least one authorization protocol for controlling access.

8. The method according to one of the preceding claims, further characterized in that the at-least one mobile computer (20) is connected via a network to the at-least one local computer (30) and/or the at-least one intermediate computer (60) and/or [the one or more] central computers (40, 50).

9. A system for data management with
at least one mobile computer (20) provided with a software program (front end), for the input and storage of data
at least one central computer (40, 50) with a software program (back-end system) for collecting and for storing data,
at least one local computer (30) for the exchange of data between the at-least one mobile computer (20) and the at-least one central computer (40, 50), wherein the software (middleware) of the local computer (30) serves at least also for the intermediate conversion and interface control,
is hereby characterized in that
another software program (customizer) is provided, with which individual data for one or more mobile computers (20), which is application-specific, can be collected and stored on a computer (20, 30, 60),
whereby an exchange of data between the mobile computer (20) and the computer (20, 30, 60) is made in such a way that the software present on the mobile computer (20) (front end) is configured in an application-specific manner.

10. The system according to claim 9, further characterized in that an intermediate computer (60) is provided, on which the additional software (customizer) is stored.

11. The system according to one of claims 9 and 10, further characterized in that front end and customizer or front end and middleware or customizer and middleware are stored on the same computer.

12. The system according to one of claims 9 to 11, further characterized in that the additional software (customizer) is provided with at least one authorization protocol for control of access.

13. The system according to one of claims 9 to 12, further characterized in that the at-least one mobile computer (20) is connected via a network to the at-least one local computer (30) and/or the at-least one intermediate computer (60) and/or the central computer (40, 50).

14. The system according to one of claims 9 to 13, further characterized in that the front end and/or middleware and/or customizer are provided in the programming language Java.

15. Use of the method according to one of claims 1 to 8 and/or of the system according to one of claims 9 to 14 for the management of patient data in a hospital.

16. Use of the method according to one of claims 1 to 8 and/or of the system according to one of claims 9 to 14, for payment transfer by means of the paybox system.

17. Use of the method according to one of claims 1 to 8 and/or of the system according to one of claims 9 to 14 for the management of inventory and ordering data.

18. Use of the method according to one of claims 1 to 8 and/or of the system according to one of claims 9 to 14 for quality control in production, particularly on production lines.

19. Use of the method according to one of claims 1 to 8 and/or of the system according to one of claims 9 to 14 as a purchasing system (sales system), a CRM system and/or a service system.
